(19) United States
(12) Patent Application Publication
(10) Pub. No.: US 2007/0192992 A1
(43) Pub. Date: Aug. 23, 2007

(54) Cover module for a computer case

(76) Inventor: Steven Su, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/359,593

(22) Filed: Feb. 23, 2006

(51) Int. Cl. E05D 7/10

(52) U.S. Cl. 16/262

(57) ABSTRACT

A cover module comprises a panel formed with a space on one side thereof, at least one hinge assembly, and a cover. The hinge assembly is demountably positioned in the space, and the cover is demountably engaged with the hinge assembly. With the hinge assembly, the cover can be demounted from and mounted to the computer case without disassembling the whole computer case. Furthermore, the users can replace the cover according to their needs whenever they wish.

### BACKGROUND OF THE INVENTION

1. Field of the Invention

The present invention generally relates to a demountable cover module for a computer case, and more particular to a cover module that can be directly mounted to and demounted from a computer case.

2. Description of Related Art

With reference to FIG. 1, a cover 20a pivotally connected to a computer case 10a is shown. This cover is difficult to replace, and can be replaced only by disassembling the whole computer case 10a. The user must undo many fastening parts and devices before it is possible to replace the cover. Furthermore, it is also difficult for the user to frequently change the appearance of the computer case by utilizing different types of covers according to his/her preferences.

Therefore, in view of the above drawbacks, the inventor proposes the present invention to overcome the above problems based on his deliberate researches and related principles.

### SUMMARY OF THE INVENTION

The object of the present invention is to provide a demountable cover module for a computer case, which can be directly demounted from and mounted to the computer case, allowing the user to replace, repair or even update the cover easily. Another object of the present invention is to provide a demountable cover module for a computer case allowing the user to frequently change the appearance of the computer case by mounting different types of covers to the computer case according to his/her preferences.

In order to achieve the above objects, the present invention provides a cover module for a computer case, which comprises a panel formed with a space on one side thereof, at least one hinge assembly demountably positioned in the space, and a cover demountably engaged with the hinge assembly. The panel is substantially a front panel of the computer case (not shown) and the hinge assembly is positioned in a space exterior to the computer case, and thus the cover can be easily demounted from and mounted to the hinge assembly.

### BRIEF DESCRIPTION OF THE DRAWINGS

The characteristics and the technical contents of the present invention will be further understood in view of the detailed description and accompanying drawings. However, it should be noted that the drawings are illustrative but not used to limit the scope of the present invention. Wherein:

FIG. 1 is a perspective view illustrating a conventional cover for a computer case;

FIG. 2 is an exploded perspective view illustrating a cover module for a computer case according to a first embodiment of the present invention;

FIG. 3 is an exploded perspective view illustrating a hinge assembly of the cover module shown in FIG. 2;

FIG. 4 is a cross-sectional view illustrating the hinge assembly shown in FIG. 3 in operation during the demounting process;

FIG. 5 is a cross-sectional view illustrating the hinge assembly shown in FIG. 3 in operation during the mounting process;

FIG. 6 is an exploded perspective view illustrating a hinge assembly of a cover module for a computer case according to a second embodiment of the present invention;

FIG. 7 is a cross-sectional view illustrating the hinge assembly shown in FIG. 6 in operation during the demounting process;

FIG. 8 is a cross-sectional view illustrating the hinge assembly shown in FIG. 6 in operation during the mounting process;

FIG. 9 is an exploded perspective view illustrating a hinge assembly of a cover module for a computer case according to a third embodiment of the present invention;

FIG. 10 is an exploded perspective view illustrating hinge assemblies in combination with covers according to a preferred embodiment of the present invention; and

FIG. 11 is an exploded perspective view illustrating hinge assemblies in combination with covers according to another preferred embodiment of the present invention.

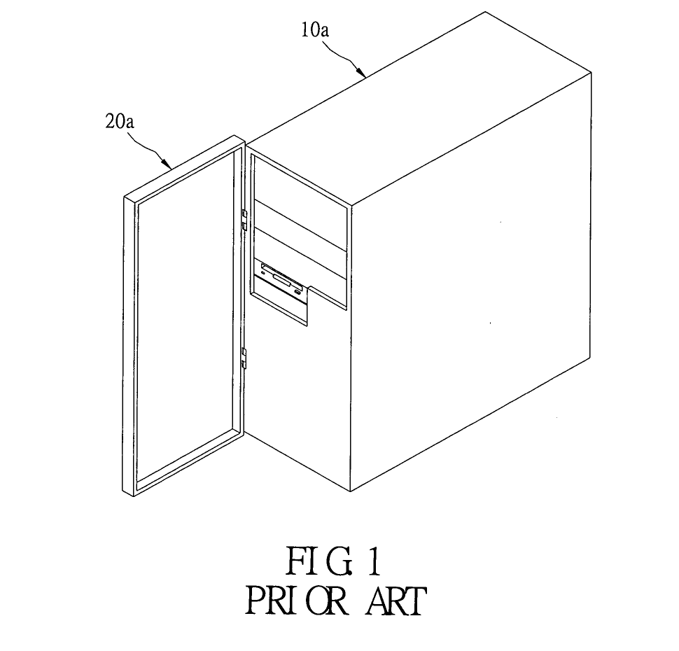

### DETAILED DESCRIPTION OF PREFERRED EMBODIMENTS

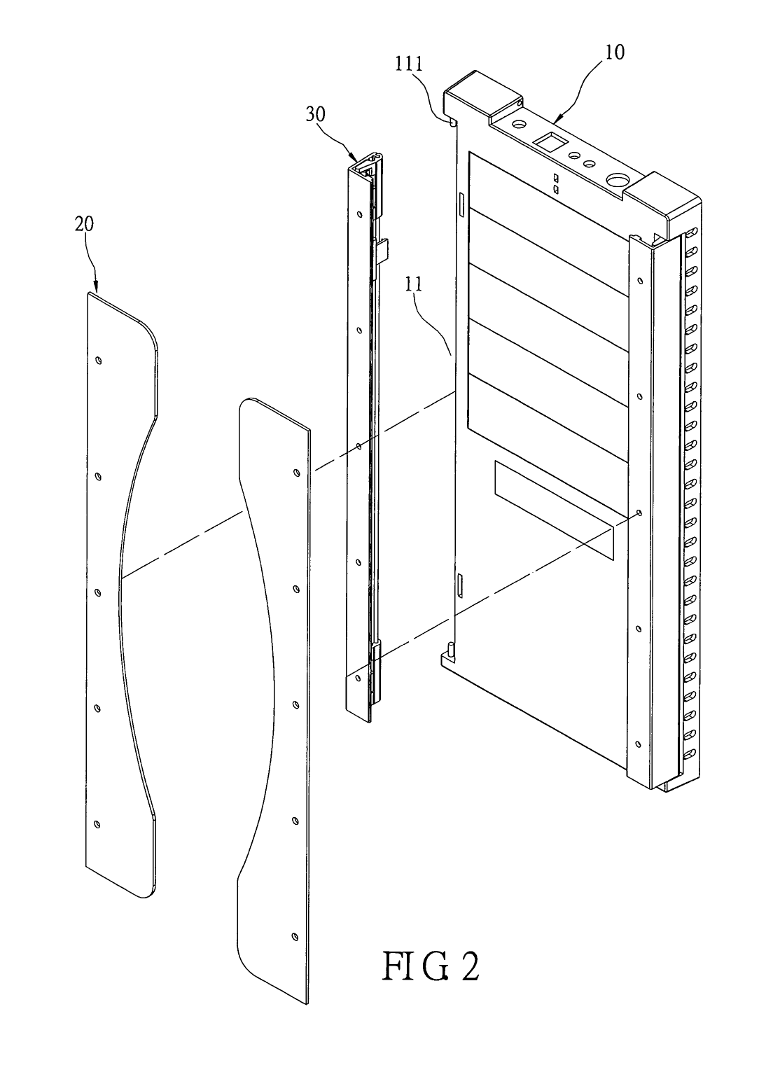

With reference to FIG. 2, the present invention provides a cover module for a computer case, which comprises a panel 10, at least one hinge assembly 30, and a cover 20. A space 11 for accommodating the hinge assembly is formed on one side of the panel 10. A pivot 111 corresponding to the hinge assembly 30 is provided in the space 11, and therefore the hinge assembly 30 is engaged with the pivots 111 and positioned in the space 11. The cover 20 is demountably connected to the hinge assembly 30 which is positioned in the space 11 formed on one side of the panel 10. Therefore, the cover 20 can be demounted from or mounted to the panel 10 without disassembling the whole computer case.

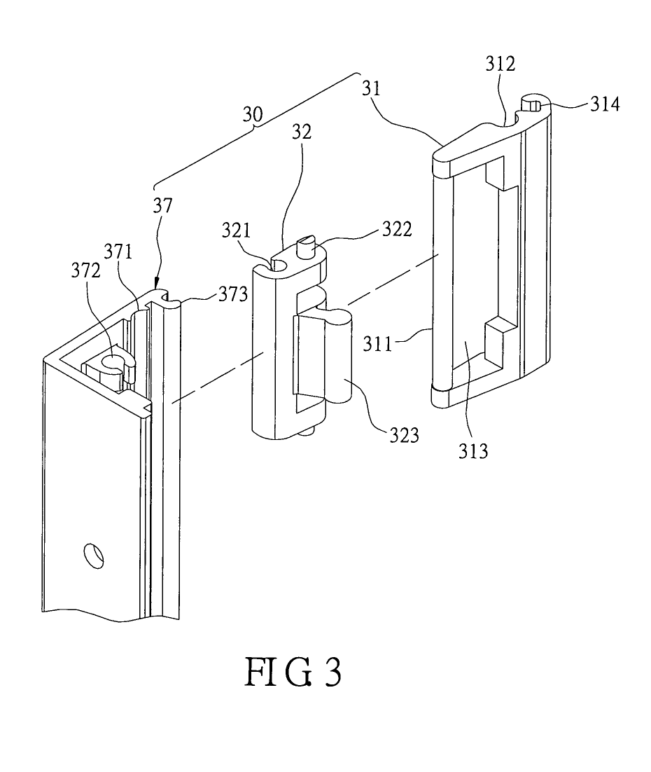

FIG. 3 illustrates the hinge assembly 30 shown in FIG. 2 in detail. The hinge assembly 30 comprises a holding member 31, a releasing member 32, and a connecting member 37. The holding member 31 has a hook configuration. A cylindrical lever 311 is provided at the front end of the holding member 31, and a T-shaped space 313 is formed adjacent thereto. The space 313 allows the releasing member 32 to move freely therein. A groove 314 of a square configuration is formed at the rear end of the holding member 31. A curved locking portion 312 is formed between the groove 314 and the space 313.

A pair of coaxial posts 322 is protrudedly formed on the top and bottom surface of the rear end of the releasing member 32, respectively. A recess portion 321 corresponding to the lever 311 is formed on the front end of the releasing member 32. The lever 311 is rotatably engaged with the recess portion 321. An inclined tongue 323 having a cylindrical end laterally extends from the releasing member 32. Once the tongue 323 is pushed, the releasing member 32 can rotate in the space 313.

A connecting member 37 has a L-shaped configuration. A C-ring portions 372 are provided in the interior of the connecting member 37. The C-ring portions 372 are engaged with the posts 322 inside the connecting member 37, allowing the releasing member 32 to rotate about the connecting member 37 with the posts 322 thereof. A hook portion 373 extends from the interior of the connecting member 37 and reaches into the groove 314, allowing the connecting member 37 to be engaged with the holding member 31. A curved abutting portion 371 is formed, adjacent to the hook portion 373, on the connecting member 37. The abutting portion 371 and locking portion 312 abut against the pivots 111, allowing the hinge assembly 30 to be engaged with the pivots 111.

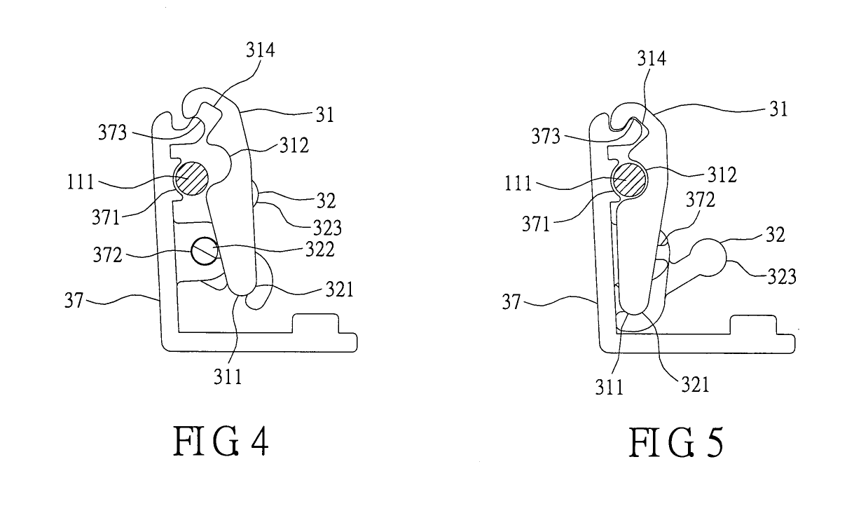

As shown in FIG. 4, when the user would like to demount the hinge assembly 30, he/she just pushes the tongue 323 to drive the releasing member 32 to rotate about the posts 322 and, simultaneously, the holding member 31 moves to disengage the abutting portion 371 of the connecting member 37 and the locking portion 312 from the pivots 111. Thus, the hinge assembly 30 is released from the space 11, and the cover 20 along with the hinge assembly 30 can be demounted from the computer case 10. As shown in FIG. 5, alternatively, when the user would like to mount the hinge assembly 30, he/she just pulls the tongue 323 to drive the releasing member 32 to rotate about the posts 322 and, simultaneously, the holding member 31 moves to engage the abutting portion 371 of the connecting member 37 and the locking portion 312 with the pivots 111. Thus, once the hook portion 373 is engaged with the groove 314, the hinge assembly 30 is engaged with the pivots 111 simultaneously and both are accommodated in the space 11.

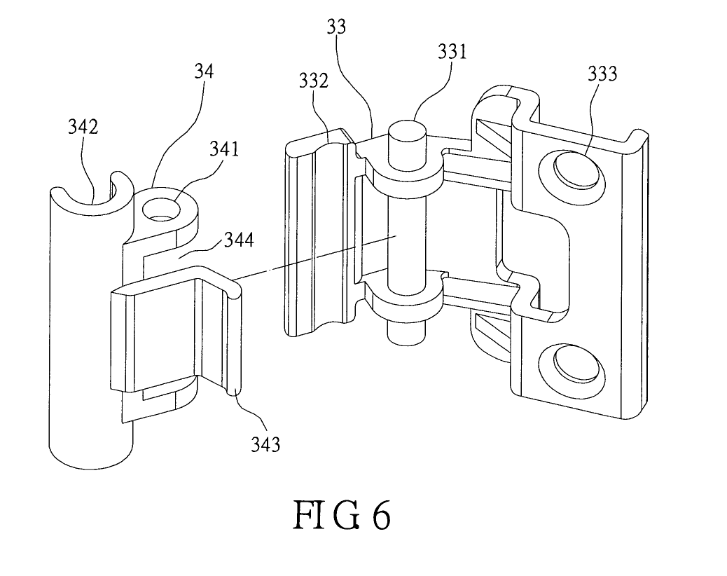

Referring to FIGS. 6 to 8, an alternative hinge assembly 30 is shown. The hinge assembly 30 comprises a stationary member 33, a clamping member 34, and a connecting member 37. A cylindrical rod 331 is centrally formed in the stationary member 33. A curved groove 332 is formed on one side of the rod 331, and a pair of holes 333 is formed on the other side of the rod 331. The stationary member 33 is engaged with the connecting member 37 by means of the holes 333.

The clamping member 34 comprises a clamping portion 342, and O-ring portions 341 formed adjacent to the upper and lower edges, respectively, of the clamping portion 342. A space 344 is formed between the O-ring portions 341. The clamping member 34 also comprises an L-shaped member 343 laterally extending therefrom. The clamping member 34 accommodates the rod 331 in the space 344. Since the O-ring portions 341 are pivotally connected with the rod 331, the clamping member 34 can rotate about the stationary member 33. Thus, the clamping portion 342 and the groove 332 are engaged with the pivots 111, and consequently, the hinge assembly 30 is engaged with the pivots 111.

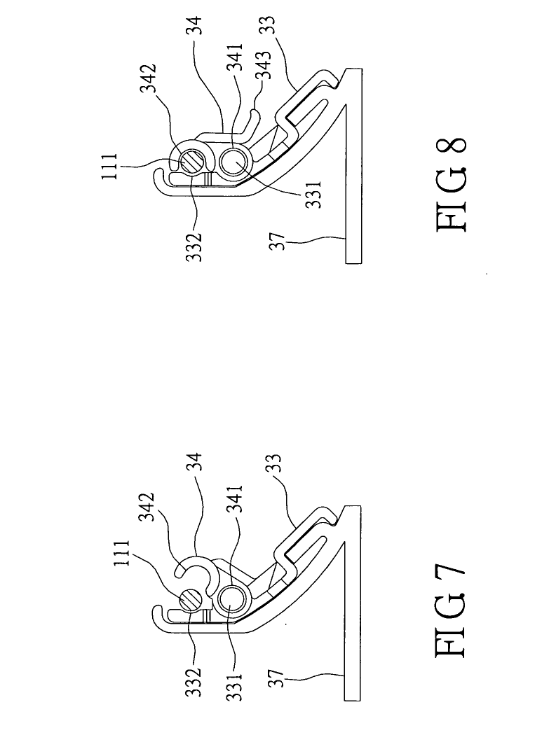

Referring to FIG. 7, when the user would like to demount the hinge assembly 30, he/she just presses the L-shaped member 343 of the clamping member 34 to drive the clamping member 34 to rotate about the stationary member 33, allowing the clamping portion 342 to be released from the original position where it was engaged with the pivots 111. Thus, the hinge assembly 30 is released from the space 11, and consequently, the hinge assembly 30 can be directly demounted from the panel 10. As shown in FIG. 8, on the other hand, when the user would like to mount the hinge assembly 30, he/she just presses the L-shaped member 343 to drive the clamping member 34 to rotate about the rod 331, allowing the clamping portion 342 and groove 332 to be engaged with the pivots 111. Thus, the hinge assembly 30 is engaged with the pivots 111 and accommodated in the space 11.

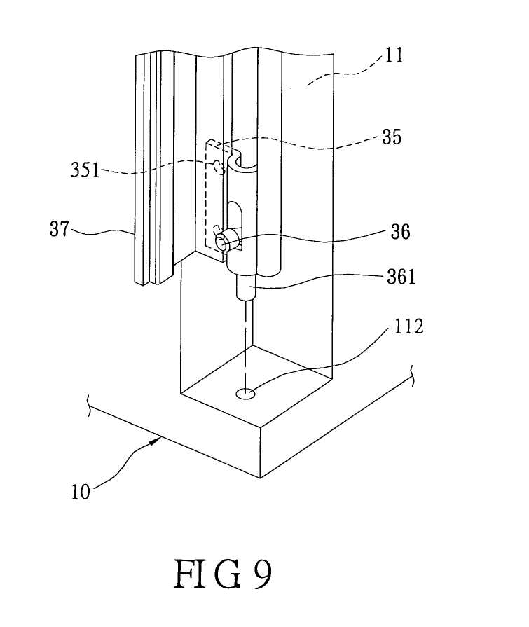

Referring to FIG. 9, an alternative connection between the space 11 and the hinge assembly 30 is shown. The space 11 is provided with a hole 112 that corresponds to the hinge assembly 30. The hinge assembly 30 comprises an attaching member 35, a latching member 36, and a connecting member 37. The attaching member 35 is provided with a pair of holes 351. The attaching member 35 can be screwed with the connecting member 37 by the pair of holes 351. Just like a latch, the latching member 36 is slidably connected with the attaching member 35. The latching member 36 is provided with a projection 361. When latching member 36 is moving with respect to the attaching member 35, the projection 361 will reach out from the attaching member 35 and insert into the hole 112, allowing the hinge assembly 30 to be engaged with the hole 112. If the user would like to demount the hinge assembly 30 from the panel 10, he/she can just move the latching member 36 in the direction that allows projection 361 to disengage from the hole 112. Thus, the hinge assembly 30 can be separated from the space 11 and directly demounted from the panel 10. Alternatively, if the user would like to mount the hinge assembly 30 to the panel 10, he/she can just move the latching member 36 in the direction that allows the projection 361 to reach out from the attaching member 35 and insert into the pivot 111. Thus, the hinge assembly 30 can be engaged with the hole 112 and accommodated in the space 11.

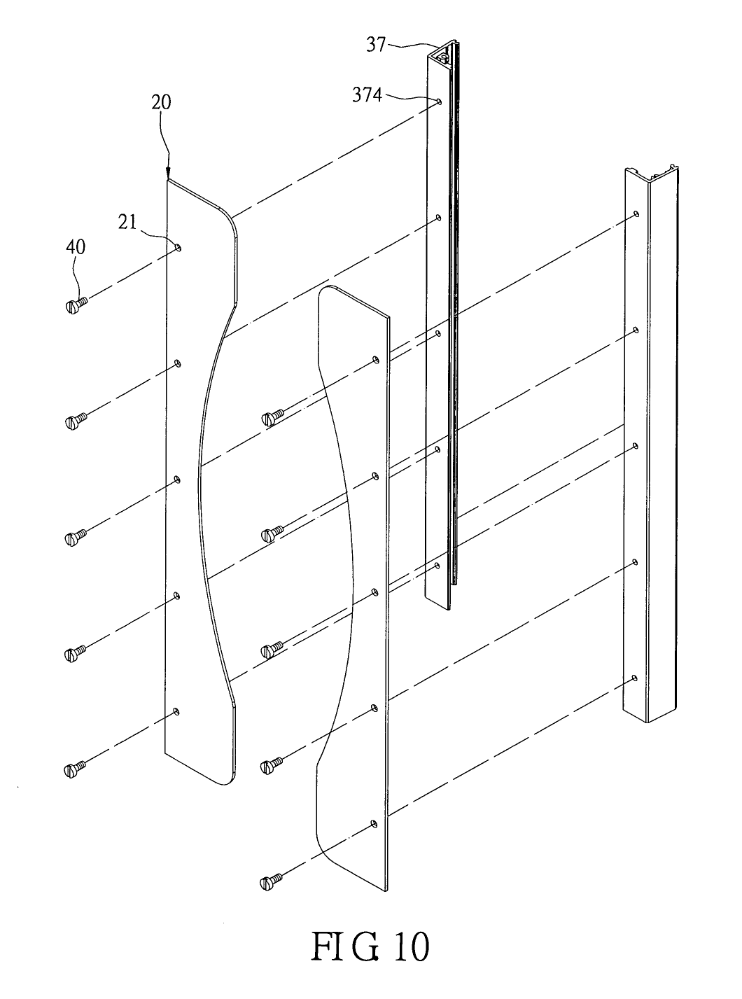

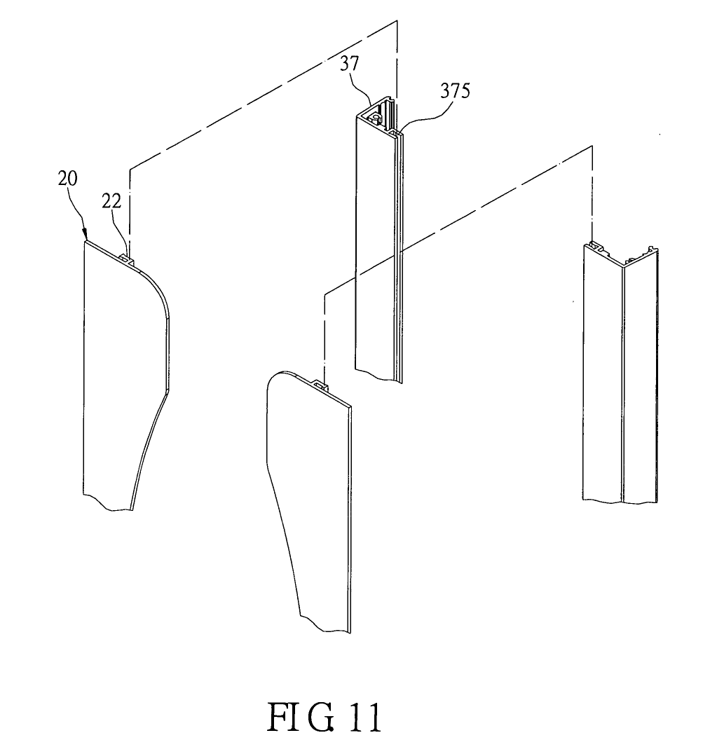

Referring to FIG. 10, the cover 20 is demountably connected with the hinge assembly 30. Since the cover 20 is provided with at least one hole 21, screws 40 can be fastened with holes 374 of the connecting member 37 through the holes 21. Thus, the cover 20 is screwed with the hinge assembly 30. Once the screws are loosened, the cover 20 can be demounted from the hinge assembly 30.

Referring to FIG. 11, an alternative connection between the cover 20 and the hinge assembly 30 is shown. The cover 20 is provided with an L-shaped hook 22 on the inner surface thereof, and the connecting member 37 is provided with a groove 375 corresponding to the L-shaped hook 22. Thus, the L-shaped hook 22 of the cover 20 can be engaged with the groove 375, allowing the cover 20 to be demountably connected to the hinge assembly 30.

In view of the above, according to the present invention, with the aid of the hinge assembly, the cover can be replaced without demounting the panel, nor loosening so many screws and disassembling the whole computer case. The present invention makes replacing a cover of a computer quick and convenient replacement, and also allows the user to change the appearance of his/her computer case according to his/her preferences.

Although the present invention has been described with reference to the foregoing preferred embodiments, it will be understood that the invention is not limited to the details thereof. Various equivalent variations and modifications may occur to those skilled in the art in view of the teachings of the present invention. Thus, all such variations and equivalent modifications are also embraced within the scope of the invention as defined in the appended claims.

What is claimed is:

1. A cover module for a computer case, the cover module comprising:
a panel formed with a space on one side thereof;
at least one hinge assembly demountably positioned in the space; and
a cover demountably engaged with the hinge assembly.

2. The cover module according to claim 1, wherein a pivot is provided in the space, the hinge assembly comprises a holding member having a lever and a locking portion, a releasing member formed with a recess, and a connecting member having an abutting portion, the holding member is engaged with the recess of the releasing member by the lever, and the locking portion of the holding member and the abutting portion of the connecting member abut against the lever of the holding member.

3. The cover module according to claim 1, wherein a pivot is provided in the space, the hinge assembly comprises a stationary member having a rod and is formed with a groove, a clamping member having an O-ring portion and a clamping portion, and an attaching member provided with a hole, the stationary member is fastened to the attaching member, the clamping member is pivotally connected with the rod of the stationary member by the O-ring portion thereof, and the clamping portion and the groove clamp against the pivots.

4. The cover module according to claim 1, wherein a hole is provided in the panel, the hinge assembly comprises an attaching member, a latching member and a connecting member, the latching member is screwed to the connecting member, the latching member is slidably positioned inside the attaching member, and the latching member is provided with a projection inserted into the hole of the panel.

5. The cover module according to claim 1, wherein the cover is screwed with the hinge assembly.

6. The cover module according to claim 1, wherein the cover is engaged with the hinge assembly.
